(19) United States
(12) Patent Application Publication
(10) Pub. No.: US 2021/0206915 A1
(43) Pub. Date: Jul. 8, 2021

(54) TRANSPARENT BRANCHED POLYCARBONATE

(71) Applicant: SABIC GLOBAL TECHNOLOGIES B.V., Bergen op Zoom (NL)

(72) Inventors: Roshan Kumar Jha, Bangalore (IN); Abdul Salam Thelakkadan, Riyadh (SA); Thavamani Ponniah, Riyadh (SA); Rajendra Singh, Riyadh (SA); Sijun Li, Bergen op Zoom (NL)

(21) Appl. No.: 17/059,750

(22) PCT Filed: Jun. 4, 2019
(86) PCT No.: PCT/IB2019/054641

§ 371 Date: Nov. 30, 2020

(30) Foreign Application Priority Data
Jun. 4, 2018 (EP) 18175713.9

(51) Int. Cl. C08G 64/06; C08L 69/00; C08G 64/42; C08L 51/08; C08L 25/14; C08F 220/32

(52) U.S. Cl. CPC C08G 64/06; C08L 69/005; C08G 64/42; C08L 51/08; C08L 2203/30; C08F 220/325; C08L 2201/10; C08L 2203/10; C08L 25/14

(57) ABSTRACT

A method for preparing a modified polycarbonate comprising i) providing a polycarbonate prepared by the melt transesterification of a bisphenol and a diaryl carbonate preferably having a Fries branching level of from 750 to 2000 ppm, ii) combining said polycarbonate and from 0.10-0.75 wt. %, based on the amount of polycarbonate, of a modifier, iii) reacting said modifier and said polycarbonate in molten state at a temperature of from 250-300° C. and a reaction time of at least 30 seconds so as to form the modified polycarbonate, wherein said modifier is a styrene-(meth)acrylate copolymer containing glycidyl groups and having i) from 250 to 500 gram epoxy groups per mol and ii) a weight average molecular weight of from 3000 to 8500 g/mol, and wherein said modified polycarbonate has a transmittance of at least 85% and a haze of at most 5% as determined in accordance with ASTM D1003-13 on an injection moulded sheet having a thickness of 3 mm.

The present invention relates to a method for preparing an aromatic polycarbonate, in particular a polycarbonate having, in combination, a high light transmittance, a low haze and high melt strength. The present invention further relates to the polycarbonate obtainable and/or obtained by the said method and to articles prepared from such polycarbonate as well as to the use of said polycarbonate in blow moulding or extrusion processes.

Polycarbonate is the material of choice for many applications including extruded sheets, panels, multi-wall panels and hollow containers, such as for example water bottles. The manufacture of more complex structures, such as multi-wall panels and relatively high volume hollow containers, such as for example water bottles, require the polycarbonate to have a certain minimum level of melt strength. In order to increase the said melt strength it is known to use branched polycarbonate. Branched polycarbonate may be manufactured in several ways. In the interfacial process it is known to use branching agents in order to introduce a desired amount of chain branching. Such a process is disclosed for example in EP2209616. In the melt transesterification process for making polycarbonate the use of chain branching agents is also known. It is however noted that in the melt transesterification process an inherent mechanism for creating a certain amount of branching is present. Such inherent branching is referred to as Fries branching, which may be controlled by selecting the appropriate combination of the type of catalyst and the applied process settings like temperature(s), pressure(s) and residence time(s) in the oligomerisation and polymerisation sections of the said process.

In order to run polycarbonate manufacturing units based on the melt transesterification process economically it is preferred that the product mix that is made on a production line is kept to a reasonable level, so that changeover losses and risk of off-spec material is reduced to a minimum. It is further preferred that the number chemicals used in the process is also kept to a minimum and preferably is limited to the monomers and the catalyst. The addition of a branching agent in the melt transesterification process adds technical complexity and furthermore increases the size of the product mix.

It is therefore an object of the invention to provide a process for the manufacture of polycarbonate having in combination a desired melt strength and good light transmittance and low haze which can produced in a cost effective manner.

The present invention relates to a method for preparing a modified polycarbonate comprising:
providing a polycarbonate prepared by the melt transesterification of a bisphenol and a diaryl carbonate,
combining said polycarbonate and from 0.10-0.75 wt. %, preferably from 0.10-0.65 wt. %, based on the amount of polycarbonate, of a modifier,
reacting said modifier and said polycarbonate in molten state so as to form the modified polycarbonate,

wherein said modifier is a styrene-(meth)acrylate copolymer containing glycidyl groups and having i) from 250 to 500 gram epoxy groups per mol and ii) a weight average molecular weight of from 3000 to 8500 g/mol, and

wherein said modified polycarbonate has a transmittance of at least 85% and a haze of at most 5% as determined in accordance with ASTM D1003-13 on an injection moulded sheet having a thickness of 3 mm.

More in particular the present invention relates to a method for preparing a modified polycarbonate comprising:
providing a polycarbonate prepared by the melt transesterification of a bisphenol and a diaryl carbonate preferably having a Fries branching level of from 750 to 2000 ppm,
combining said polycarbonate and from 0.10-0.75 wt. %, based on the amount of polycarbonate, of a modifier,
reacting said modifier and said polycarbonate in molten state at a temperature of from 250-300° C. and a reaction time of at least 30 seconds so as to form the modified polycarbonate,

wherein said modifier is a styrene-(meth)acrylate copolymer containing glycidyl groups and having i) from 250 to 500 gram epoxy groups per mol and ii) a weight average molecular weight of from 3000 to 8500 g/mol, and

wherein said modified polycarbonate has a transmittance of at least 85% and a haze of at most 5% as determined in accordance with ASTM D1003-13 on an injection moulded sheet having a thickness of 3 mm.

By application of the method according to the invention the aforementioned object is met at least in part.

An advantage of the method according to the invention is that it allows the manufacture of high melt strength polycarbonate independent from the manufacture of the polycarbonate to be modified. In other words, the method according to the invention allows the use of standard grade (linear) polycarbonate thereby avoiding the use of chain branching agents in the melt transesterification process.

The term “melt transesterification” in the context of the manufacture of polycarbonate is well known to the skilled person and refers to the direct reaction of bisphenol and a diaryl carbonate. Thus, the present invention does not relate to the interfacial process for making polycarbonate usually involving the reaction of phosgene and bisphenol A in a solvent. Melt transesterification processes are well known to a skilled person as are method for controlling the level of Fries branching which depends inter alia on the type and amount of catalyst, the temperature(s) used in the —usually multi-stage—process and the residence time.

The bisphenol is preferably bisphenol A (BPA) and the diaryl carbonate is preferably diphenyl carbonate (DPC). In the context of the present invention the monomers are, however, not strictly limited to DPC and BPA. Thus other bisphenols and for example substituted diphenyl carbonates may also be used. In view of their commercial availability it's nonetheless preferred that the polycarbonate is based on the reaction between BPA and DPC. For the avoidance of doubt it is noted that the polycarbonate is a polycarbonate obtained by the melt transesterification of a diaryl and a bisphenol, preferably diphenyl carbonate and bisphenol A. Apart from end-capping agents it is preferred that in the melt transesterification no other monomers are used and the polycarbonate is therefore preferably a polycarbonate homopolymer such as a bisphenol A polycarbonate homopolymer.

The polycarbonate is a linear polycarbonate meaning that the melt transesterification was carried out on the basis of the bisphenol and diarylcarbonate in absence of any branching agent, such as multi-functional alcohols.

The melt flow index, or melt flow rate, of the polycarbonate, i.e. the polycarbonate before modification, is preferably from 3.0 to 12 g/10 min as determined in accordance with ASTM D 1238 (1.2 kg, 300° C.). Depending on the application the melt flow index may be from 5 to 8 g/10 min.

The polycarbonate obtained by the transesterification of bisphenol and diarylcarbonate may have a Fries branching level of from 750 to 2000 ppm. The term Fries branching is known to the skilled person and refers inter alia to the structures (1) to (5)

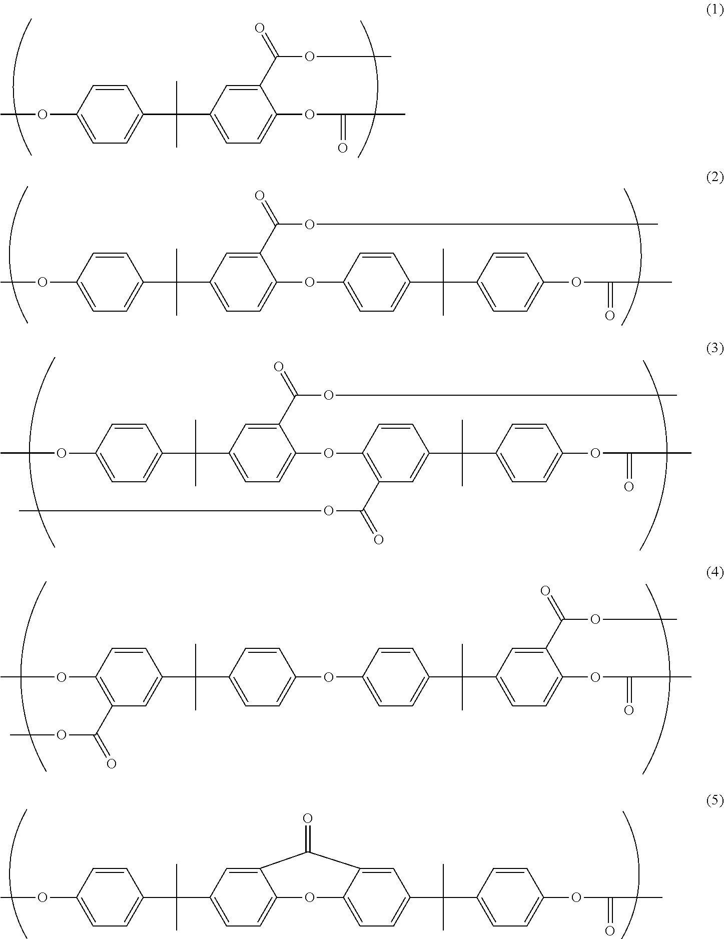

as disclosed in EP2174970, yet may include further branched structures which are chemical variations of the structures (1)-(5) above. The exact chemical mechanism for Fries branching is not completely known. Measuring Fries content is known to a skilled person.

In general it is preferred that the Fries branching level is kept relatively low because a too high level of Fries results in a reduction of the impact properties of the polycarbonate, in particular for lower molecular weight grades. Accordingly it is preferred that the level of Fries branching is from 500 to 2000 ppm, more preferably from 500 to 1500 ppm or even from 500 to 1000 ppm.

According to the method of the present invention the said linear polycarbonate is modified to introduce a certain amount of branching.

The modifier used to modify the linear polycarbonate obtained via the melt transesterification is a styrene-(meth) acrylate copolymer containing glycidyl groups and having i) from 250 to 500 gram, preferably from 200 to 400 gram, more preferably from 250-350 gram epoxy groups per mol and ii) a weight average molecular weight of from 3000 to 8500 g/mol. The term epoxy groups per mol as used herein is equivalent to the term epoxy equivalent weight. The modifiers used in the method of the invention are disclosed for example in WO 03/066704 and are commercially available for example as Joncryl™ ADR4368C, available from BASF. In the context of the present invention the term modifier is used to indicate that the styrene-(meth)acrylate copolymer containing glycidyl groups is purposely reacted with the polycarbonate in order to induce branching. The use of these materials as hydrolysis stabilisers, such as disclosed in US2007/0191518 and US 2008/0119631 differs from the use of the said copolymers in the method according to the present invention in that according to the method of the invention the copolymer reacts with the polycarbonate so as to yield a modified polycarbonate. The modified polycarbonate contains an amount of unreacted glycidyl (or epoxy) groups in the styrene-(meth)acrylate copolymer that is at most 50%, more preferably at most 40% of the initial amount added in the method according to the invention. In an embodiment the amount of unreacted glycidyl groups is at least 10%, preferably at least 20%, more preferably at least 30% of the said initial amount. The extent of modification results inter alia from the temperature and total reaction time during the process with higher temperatures and/or longer reaction times resulting in a lower amount of unreacted glycidyl groups. An advantage of a certain residual amount of glycidyl groups is that the modified polycarbonate not only has the appropriate melt strength but also exhibits an improved hydrolytical stability.

More in particular the modifier is of the following chemical structure

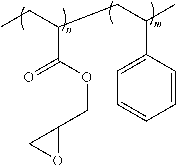

Wherein n and m are selected such that the modifier has, in combination, a weight average molecular weight of from 3000 to 8500 g/mol and from 250 to 500 gram epoxy groups per mol.

The amount of modifier used in the method disclosed herein is preferably from 0.10 to 0.65 wt. %, more preferably from 0.10 to 0.60 wt. %, even more preferably from 0.20-0.50 wt. %, based on the amount of polycarbonate.

An important aspect of the present invention lies in the increase of the melt strength of the polycarbonate to be modified. The present inventors have found that an indicator for the melt strength is represented by the tan δ of the (modified) polycarbonate. The tan δ corresponds to the ratio of the loss modulus (G″) and the storage modulus (G′) and is determined at 0.1 rad/s and 280° C. using a plate-plate rheology measurement. The lower the tan δ, the higher the melt strength of a polymer is. In accordance with the present invention the tan δ of the modified polycarbonate is at most 90% of the tan δ of the polycarbonate, i.e. the polycarbonate before modification. It is preferred however that the tan δ of the modified polycarbonate is at most 70%, more preferably at most 50%, even more preferably at most 20% of the tan δ of the polycarbonate.

The absolute value of the tan δ of the modified polycarbonate is preferably at most 15, more preferably from 2-15, even more preferably from 5-12.

The reaction between the polycarbonate and the modifier is carried out while the reactants are in molten state, which can be achieved when the modification reaction is carried out at a temperature of from 250 to 350° C., such as from 250-320° C., preferably from 270 to 300° C., more preferably from 275-300° C. It is preferred to use a temperature lower than 300° C. to avoid undesirable coloration, in particular if the modified polycarbonate is to undergo a further heat cycle after the modification reaction. Thus it is preferred that the reaction is carried out at a temperature of at most 299° C., such as from 250-299° C. or 250-275° C. The reaction may be carried out in any melt mixing device suitable for the processing of thermoplastic materials. It is preferred however that the reaction is carried out in an extruder, such as a single screw or twin-screw extruder. The modifier may be added via a separate feed to the extruder or may be premixed with the polycarbonate prior to feeding to the extruder. It is preferred however that that the modifier is fed to the extruder via a separate side feed. In order for the reaction to reach the desired level of modifier conversion the residence time in the extruder is preferably at least 30 seconds, such as from 30-300 seconds, more preferably from 30 to 120 seconds. Generally, longer residence times are needed at more moderate temperatures. The extruder may be integrated with the plant to manufacture the polycarbonate to be modified, which allows the polycarbonate to be added to the said extruder at an elevated temperature thereby saving energy cost. Alternatively pellets or granules of ready-made polycarbonate are used, allowing the manufacture of modified polycarbonate at a location remote from the location where the polycarbonate is manufactured.

In an aspect the present invention relates to the modified polycarbonate obtained or obtainable by the method according to the invention. This polycarbonate distinguishes chemically from other types of polycarbonate in that the modifier is now incorporated into the polycarbonate chains.

The present invention also relates to articles consisting of or comprising the modified polycarbonate.

The modified polycarbonate preferably has an Izod Notched impact strength of at least 60 kJ/m² as determined in accordance with ISO 180/A on a sample having a thickness of 3 mm and at a temperature of 23° C.

The modified polycarbonate may be used for the manufacture of articles by means of extrusion or by means an injection blow moulding or an extrusion blow moulding process. In an aspect of the present invention the preparation of the modified polycarbonate is integrated in the process for the manufacture of the article, thereby saving costs and energy and furthermore limiting the amount of heat cycles to which the polycarbonate is exposed, which is advantageous in particular for the color properties of the (modified) polycarbonate.

In a preferred embodiment the modified polycarbonate is used for the manufacture of bottles, in particular water bottles, having a volume of at least 15 liter, preferably at least 18.9 liter (corresponding to 5 US Gallon). A maximum volume may be 100, 75, 50 or 30 liter.

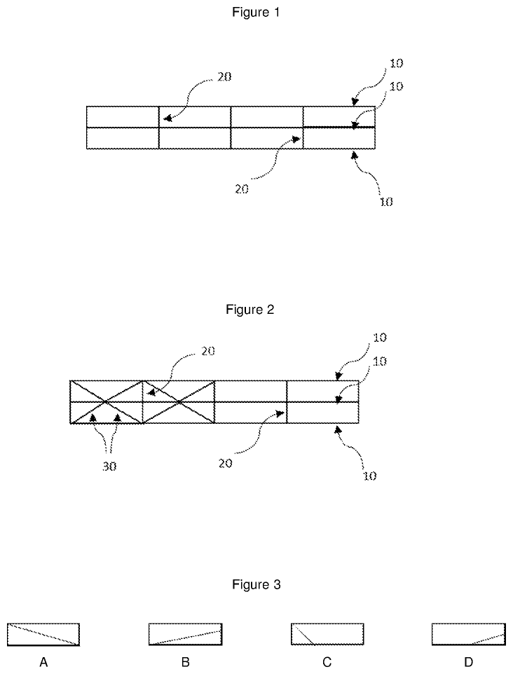

In the embodiment where the modified polycarbonate is processed into articles via an extrusion process it is preferred that the article is a single or multi-layer sheet or a multi-layer panel having substantially parallel layers connected by ribs. FIG. 1 shows an example of a multilayer panels having main layers 10 and ribs 20 substantially vertical to and connecting main layers 10. The main layers and ribs define cells 30. FIG. 1 shows two main layers connected by a total of ten ribs 20. A skilled person will understand that the number of main layers may also be more than two and may for example be between 2 and 15, such as 5, 6, 8, 10, 12. Also the number of ribs may vary depending on the application and the ribs may be spaced in an even or uneven manner. The term substantially vertical is to be interpreted such that the angle between a rib and a main layer is from 80-100°.

In a further embodiment, as schematically shown in FIG. 2, the multi-layer panel further comprises reinforcing ribs 40, which are typically disposed diagonally inside cells 30.

Multi-layer panels may contain such reinforcing ribs 40 in each cell or in only a limited number of cells, depending on the desired properties of the multi-layer panel. In FIG. 2 cells 30 contain 2 reinforcing ribs which essentially divide one cell 30 into 3 sub-cells. The invention is however not limited to such embodiments and other configurations of reinforcing ribs may also be applied, examples of which can be found in FIGS. 3A-3D.

Finally it will be appreciated that several variations of reinforcing ribs may be used in combination in the same call and/or in the multi-layer panel.

The modified polycarbonate may be used in polycarbonate compositions comprising at least a portion of the modified polycarbonate. Preferably such compositions comprise at least 40 wt. %, more preferably at least 60 wt. %, 80 wt. %, 90 wt. %, 95 wt. % or 98 wt. % of the modified polycarbonate. Polycarbonate compositions may contain further polymers, such as polycarbonates other than the modified polycarbonate, linear or branched polycarbonate copolymers, acrylonitrile butadiene styrene copolymer, styrene acrylonitrile copolymers, polyesters such as polybutylene terephthalate or polyethylene terephthalate, flame retardants, anti-drip agents, mould release agents, slip agents, colorants such as pigments or dyes, UV stabilisers, (near) infra-red absorbers, anti-oxidants, fillers, reinforcing agents, impact modifiers, anti-static agents, heat stabilisers, and the like.

The method of the invention is preferably a continuous method allowing the manufacture of a constant production quality. A batch method or a semi-continuous method, or more in general a method wherein the reaction time is not constant is less preferred because it may result in fluctuations of product properties and/or degree of modification. Accordingly the present invention preferably excludes a method wherein the modification is carried out on conversion equipment wherein the (modified) polycarbonate only flows intermittently through said equipment. Thus, typically the present invention excludes performing the method of the invention in an injection moulding process.

The present invention further relates to a method for the manufacture of a hollow container, preferably having an internal volume of at least 15 liter, comprising the steps of i) preparing a modified polycarbonate in accordance with the method disclosed herein and ii) blow moulding the so modified polycarbonate into the hollow container. In an embodiment the preparing of the modified polycarbonate comprises cooling the modified polycarbonate so as to obtain a solid form thereof. In such an embodiment the modified polycarbonate is preferably cooled to below 100° C., more preferably to below 50° C., such as to room temperature. The modified polycarbonate may be cut into pellets prior or after the cooling using methods known to a skilled person per se. The pellets may thereafter be processed, i.e. molten, in the equipment for the manufacture of the hollow container.

The present invention further relates to a method for the manufacture of an extruded single layer sheet, a multi-wall sheet or a profile, the method comprising the steps of i) preparing a modified polycarbonate in accordance with the method disclosed herein and ii) extruding the so modified polycarbonate into the sheet or profile, as the case may be. In an embodiment the preparing of the modified polycarbonate comprises cooling the modified polycarbonate so as to obtain a solid form thereof. In such an embodiment the modified polycarbonate is preferably cooled to below 100° C., more preferably to below 50° C., such as to room temperature. The modified polycarbonate may be cut into pellets prior or after the cooling using methods known to a skilled person per se. The pellets may thereafter be processed, i.e. molten, in the equipment for the manufacture of the sheet or profile.

The present invention will be further elucidated by the following non-limiting examples.

Measurement Methods.

The amount of Fries branching was determined by dissolving 3.0 gram of polycarbonate in 7.6 ml of a mixture of solvents containing 5 ml of tetrahydrofuran and 2.6 ml of a 10% potassium hydroxide solution in methanol. The sample is heated at a temperature for 20 minutes at 40° C. after which 1.4 ml of acetic acid is added after which mixing was continued for at least 5 minutes. The resulting mixture was analyzed by high performance liquid chromatography (HPLC) using an Agilent 1100 G1365B series HPLC device equipped with a UV detector operating at a wavelength of 320 nm and using p-terphenyl as the internal standard. The column is an Agilent Zorbax Eclipse XDB-C18 4.6×75 mm operated at a temperature of 35° C.

Rheological properties were determined using an ARES G2 Rheometer having a plate-plate geometry consisting of two circular plates having a diameter of 30 mm.

Measurements were carried out at a temperature of 280° C. under a nitrogen atmosphere. Multi-wave time-sweep tests were carried out at a temperature of 280° C. to evaluate the structural stability of the modified polycarbonate at different frequencies as a function of time. The multi-wave signal consisted of nine pure sinusoidal waves having frequencies: 0.1, 0.2, 0.4, 0.8, 1.6, 3.2, 6.4, 12.8 and 25.6 rad/s. The overall peak strain was kept below 5% to be within the linear viscoelastic regime. The tan δ as reported herein is based on the first time-sweep at a frequency of 0.1 rad/s.

The blow-mouldability of the (modified) polycarbonate is expressed by the parameter R* which is calculated on the basis of the rheological data as follows.

First, the complex viscosity, q* at 1 rad/sec and 100 rad/sec is determined using a rheometer as a function of temperature. Temperature intervals can be about 1° C.

Next, the R* temperature is determined as the temperature at which the complex viscosity at 100 rad/s equals 20,000 poise.

Next, the complex viscosity at 1 rad/s is determined at the said R* temperature.

The R* value is thereafter calculated as the ratio of the complex viscosity at 1 rad/sec to the complex viscosity at 100 rad/sec (20,000 poise).

Polycarbonate resins useful for blow moulding have an R* value of from about 2.2 to about 4.5. Those made by the method of the present invention will generally have R* values from about 2.2 to about 4.2. Linear and slightly branched polycarbonate usually have an R* value of less than 2.0, usually from about 1.4-1.5.

Optical properties were determined according to standard ASTM D1003, using Haze-Gard equipment on injection moulded plaques having a thickness of 3 mm.

The (notched) impact properties were determined in accordance with ISO 180/A at room temperature (23° C.) samples prepared by injection moulding having a thickness of 3 mm.

Melt flow rate was determined in accordance with ISO 1133 at 300° C. and a 1.2 kg load.

### EXAMPLES

Samples of modified polycarbonate were prepared by modification of polycarbonate using a co-rotating twin-screw extruder with an L/D of about 41 and a screw diameter of 25 mm. The temperature ranged from 40° C. at the feed zone to 290° C. at the die. The torque was maintained in a range of from 60-70% of the maximum torque of the extruder equipment.

The following materials were used:

PC-1: Polycarbonate produced via the melt transesterification of diphenyl carbonate and bisphenol A, and having a MFR of 6 g/10 min and an amount of Fries branching of 1900 ppm. PC 1 is unquenched, meaning that after the polymerisation the catalyst is not deactivated.

PC-2: Polycarbonate produced via the melt transesterification of diphenyl carbonate and bisphenol A, and having a MFR of 10 g/10 min. PC 2 is unquenched, meaning that after the polymerisation the catalyst is not deactivated.

PC-3: Polycarbonate produced via the melt transesterification of diphenyl carbonate and bisphenol A, and having a MFR of 6 g/10 min and an amount of Fries branching of 900 ppm. PC 3 is quenched, meaning that after the polymerisation the catalyst is deactivated by addition of a suitable amount of butyl-tosylate.

Mod1: Polymeric chain extender Joncryl ADR-4368 commercially available from BASF and being a styrene-(meth)acrylate copolymer containing glycidyl groups having a Mw of 6800, a Tg of 54° C. and an epoxy equivalent weight of 285 g/mol, corresponding to about 3500 meq/kg of epoxy groups. The number of epoxy groups per unit chain length is about 23.

Mod2: Polymeric chain extender Joncryl ADR-4400 commercially available from BASF and being a styrene-(meth)acrylate copolymer containing glycidyl groups having a Mw of 7100, a Tg of 65° C. and an epoxy equivalent weight of 485 g/mol, corresponding to about 2060 meq/kg of epoxy groups. The number of epoxy groups per unit chain length is about 15.

Mod3: Polymeric chain extender Joncryl ADR-4300 commercially available from BASF and being a styrene-(meth)acrylate copolymer containing glycidyl groups having a Mw of 5500, a Tg of 56° C. and an epoxy equivalent weight of 445 g/mol, corresponding to about 2250 meq/kg of epoxy groups. The number of epoxy groups per unit chain length is about 12.

Table 1 provides an overview of the experimental data based on modifier 1 (Mod1).

TABLE 1

| | CE1 | E1 | E2 | E3 | CE2 | CE3 | CE4 |
|---|---|---|---|---|---|---|---|
| PC1 [wt. %] | 100 | 99.90 | 99.75 | 00.50 | 99.25 | 99.00 | |
| PC2 [wt. %] | | | | | | | 100 |
| Mod1 [wt. %] | 0 | 0.10 | 0.25 | 0.5 | 0.75 | 1 | 0 |
| Tanδ @ 0.1 rad/s | 99.7 | 30.5 | 12 | 10.7 | 5.7 | 4 | 42.6 |
| MFR [g/10 min] | 6.0 | 5.9 | 5.6 | 4.5 | — | — | 10 |
| Haze [%] | 1.75 | 0.8 | 1.1 | 2 | 60.2 | 48.8 | |
| Transmission [%] | 90.2 | 90.6 | 90.7 | 90.7 | 89 | 88 | NA |
| Notched impact | 69 | 67 | 67 | 66 | 55 | 57 | NA |
| strength [KJ/m²] | | | | | | | |
| R* | 2.2 | 2.5 | 3.3 | 3.7 | 7.9 | NA | NA |

From this table it is clear that the optical properties unexpectedly deteriorate at modifier loading levels of about 0.75%. Similarly the impact strength at loading levels of 0.75% reduces. The melt flow rate (MFR) of modified polycarbonate with load levels of 0.75% or higher could not be determined. The inventors believe this is indicative for undesired levels branching or possibly even cross-linking of the polycarbonate chains. Based on the experimental data the present inventors believe that modifier loading levels of from 0.10 to 0.65% result in modified polycarbonates with acceptable properties.

Further experiments were carried out with PC-2 using both modifier 1 as modifier 3. Table 2 provides an overview of these experiments.

TABLE 2

| | CE5 | E4 | E5 | E6 | E7 | E8 | E9 |
|---|---|---|---|---|---|---|---|
| PC2 [wt. %] | 100 | 99.90 | 99.75 | 99.50 | 99.90 | 99.75 | 99.50 |
| Mod1 [wt. %] | | | | | 0.10 | 0.25 | 0.50 |
| Mod3 [wt. %] | | 0.10 | 0.25 | 0.50 | | | |
| Tanδ @ 0.1 rad/s | 29.69 | NA | 21.35 | 15.08 | 18.12 | 16.45 | 7.89 |
| Haze [%] | 0.66 | 0.81 | 1.15 | 0.89 | 0.69 | 0.72 | 0.69 |
| Transmission [%] | 91.3 | 90.8 | 90.4 | 90.9 | 91.1 | 90.9 | 91.1 |

The Table 2 shows that both Mod1 as Mod2 result in good optical properties.

Experiments with PC-3 were carried out and the results are shown in Table 3 below.

TABLE 3

| | CE6 | E10 | E11 | E12 | CE7 | CE8 | E13 | CE9 | CE10 |
|---|---|---|---|---|---|---|---|---|---|
| PC3 [wt. %] | 100 | 99.90 | 99.75 | 99.50 | 99.25 | 99.0 | 99.50 | 99.25 | 99.0 |
| Mod1 [wt. %] | | 0.10 | 0.25 | 0.50 | 0.75 | 1.0 | | | |
| Mod2 [wt. %] | | | | | | | 0.50 | 0.75 | 1.0 |
| Tanδ @ 0.1 rad/s | 76 | 23 | 21 | 12 | 4.4 | 1.2 | 12 | 11 | 3.5 |
| MFR [g/10 min] | 6.0 | 6.3 | 5.4 | 3.2 | 1.6 | NA | 4.3 | 3 | 1.2 |
| Haze [%] | 0.5 | 0.5 | 0.5 | 1.5 | 10 | 76 | 0.8 | 3.7 | 36 |
| Transmission [%] | 91.3 | 91.1 | 91.1 | 91.1 | 91.1 | 89.1 | 91.2 | 91.2 | 90.5 |
| Notched impact | 77 | 78 | 75.3 | 76.4 | 70.6 | 73 | 74.8 | 74.5 | 74.5 |
| strength [KJ/m²] | | | | | | | | | |
| R* | 1.7 | 1.7 | 2.0 | 2.7 | 5.6 | 8.6 | 2.7 | 2.9 | 3.7 |

From Table 3 the present inventors conclude that the use of the modifier according to the invention is suitable for modifying both quenched as unquenched polycarbonate prepared using the melt transesterification process. Similar results are obtained in haze, transmission and impact behaviour and the R* value indicates that the material is suitable for blow moulding applications.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. A “combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. “Or” means “and/or” unless clearly indicated otherwise by context.

All cited patents, patent applications, and other references are incorporated herein by reference in their entirety. However, if a term in the present application contradicts or conflicts with a term in the incorporated reference, the term from the present application takes precedence over the conflicting term from the incorporated reference. Application EP Application No. 18175713.9, filed on Jun. 4, 2018, is incorporated herein in its entirety.

Unless specified to the contrary herein, all test standards are the most recent standard in effect as of the filing date of this application, or, if priority is claimed, the filing date of the earliest priority application in which the test standard appears.

1. A method for preparing a modified polycarbonate comprising:
providing a polycarbonate prepared by the melt transesterification of a bisphenol and a diaryl carbonate,
combining said polycarbonate and from 0.10-0.75 wt. %, based on the amount of polycarbonate, of a modifier,
reacting said modifier and said polycarbonate in a molten state at a temperature of from 250-300° C. and a reaction time of at least 30 seconds so as to form the modified polycarbonate,
wherein said modifier is a styrene-(meth)acrylate copolymer containing glycidyl groups and having from 250 to 500 gram epoxy groups per mol, and
wherein said modified polycarbonate has a transmittance of at least 85% and a haze of at most 5% as determined in accordance with ASTM D1003-13 on an injection moulded sheet having a thickness of 3 mm.

2. The method of claim 1 wherein the amount of modifier is from 0.10-0.65 wt. %.

3. The method of claim 1 further comprising cooling the modified polycarbonate to a temperature below 100° C. to obtain the modified polycarbonate in a solid form.

4. The method of claim 1 wherein the polycarbonate has a melt flow index of from 3.0-12 g/10 min as determined in accordance with ASTM D 1238 (1.2 kg, 300° C.).

5. The method of claim 1 wherein the tan δ of the modified polycarbonate is at most 90% of the tan δ of the polycarbonate, wherein tan δ=G″/G′ being the ratio of the loss modulus (G″) and the storage modulus (G′) and determined at 0.1 rad/s and 280° C. using a plate rheology measurement.

6. The method of claim 1 wherein tan δ of the modified polycarbonate is at most 15.

7. The method of claim 1 wherein the method is a continuous method.

8. A modified polycarbonate obtained by the method of claim 1.

9. The modified polycarbonate of claim 8 having an Izod Notched impact strength of at least 60 kJ/m² as determined in accordance with ISO 180/A on a sample having a thickness of 3 mm and at a temperature of 23° C.

10. The modified polycarbonate of claim 8 having an R* value, as defined herein of from 2.2-4.2.

11. An article comprising the modified polycarbonate of claim 8.

12. The article of claim 11 wherein the article is a hollow container, a single layer sheet, a multi-wall sheet or an extruded profile.

13. The article of claim 11, wherein the article is a hollow container formed by blow molding.

14. The method of claim 1, further comprising extruding the modified polycarbonate to form extruded profiles, single layer sheets or multi-wall sheets.
